(19) United States
(12) Patent Application Publication
(10) Pub. No.: US 2019/0370878 A1
(43) Pub. Date: Dec. 5, 2019

(54) Fragrance Customization System

(71) Applicant: Whiff, Inc., Carlsbad, CA (US)

(72) Inventor: Anh Hao Tran, Carlsbad, CA (US)

(21) Appl. No.: 15/997,334

(22) Filed: Jun. 4, 2018

(51) Int. Cl. G06Q 30/06; G06Q 30/02

(52) U.S. Cl. CPC G06Q 30/0631; G06Q 30/0203

(57) ABSTRACT

A method for determining user preferences for perfume fragrance using a comparison of user preferences for the individual aroma components of a perfume fragrance. By providing sequential pluralities of perfume fragrances and ascertaining user preferences for both aroma component scents and the longevity of such scents, preferences for existing perfume fragrances and custom mixed perfume fragrances can be determined.

### BACKGROUND OF THE INVENTION

### 1. Field of the Invention

The present invention relates generally to perfume and fragrance. More particularly it relates to a method for ascertaining and formulating customized fragrances for users or consumers based upon their sequential communication of scent preferences to the system provider.

### 2. Prior Art

The use of perfume by humans has occurred for centuries and it is believed perfume fragrances were first made in ancient Greece and spread to Rome and thereafter throughout the world. The application of scent to the body was practiced for a number of reasons which have changed over time. While modernly, fragrances are applied to the body to enhance the mood of the user or to provide an enhancing scent to others such as suitors, such has not always been the case. During earlier times when bathing may have been an infrequent occurrence, fragrances were applied to users to mask odors.

A perfume or fragrance, modernly, is composed of one or a plurality of individual aroma components where each emits a unique scent. Modernly, there are thousands of such aroma compounds or aroma components available, each of which emits an individual aroma scent, which can be combined in varying amounts in a mixture with a solvent such as alcohol, to yield a final fragrance. While simple fragrances may include one or a few aroma components with unique aroma scents dissolved in a solvent such as alcohol, other fragrances can include hundreds of aroma components in the mix with a solvent.

From the large number of perfume fragrances available, such can generally can be grouped into one of a plurality of fragrance families. Such perfume fragrances are those having key aroma components and ingredient combinations, which are in common and have similarities in fragrance and are said to be in the same fragrance family.

In formulating a final fragrance, the individual scents of various individual aroma components conventionally can be classified as notes based on their olfactory character. Conventionally, a perfume mixture yielding a final perfume fragrance is formed from a unique mixture of aroma components first aroma group or top note, a second aroma group or middle note, and a third aroma group or base note of the mixed perfume fragrance, where each is included intentionally to provide a particular harmony of scents from the aroma components.

As an example, the aroma component included for the first aroma group or top notes are those scents from aroma components which are detected immediately but fade from olfactory detection first. Such top notes are intended to provide a freshness to the blended aroma components yielding the fragrance. As might be discerned, top note aroma components invoke a first impression to one sniffing or smelling the fragrance, and in many respects are used to sell the scent of the perfume. Conventionally, such top notes are scents from the first aroma group are formed of aroma components which have a life of 5-10 minutes but make a first impression on the buyer of the fragrance. Common aroma components for this top note scent from the first aroma group, are those extracted from citrus or grasses.

The second aroma group or middle note of a mixed fragrance of a perfume, is intended to have a much longer olfactory life span and to thereby last for a number of hours. Such middle note ingredients of a perfume fragrance included from the second aroma group, are usually combinations of aroma components which are spicy, floral or fruit scents.

In the mixed fragrance, the scents from the third aroma group or base notes, are intended to give the scent to the formulated perfume a depth. It is the scents included from this third aroma group which emit a discernible fragrance which lasts the longest. Such can include aroma components from animals such as musk, or extracts of plants which yield such a longer lasting scent.

After the perfume scent has been created from the scents from the three aroma groups or notes, it is conventionally mixed with a solvent such as alcohol. The amount of alcohol in a scent can vary greatly. Most full perfumes are made of about 10-20% perfume oils dissolved in alcohol and a trace of water. Colognes contain approximately 3-5% oil diluted in 80-90% alcohol, with water making up about 10%. Toilet water has the least amount, 2% oil in 60-80% alcohol and 20% water. It is thus this mixture of top, middle and base notes of a perfume fragrance in a mix with a solvent, which a user or buyer samples and smells, to choose a perfume scent for purchase.

In purchasing a perfume, users conventionally visit a retail establishment which sells many perfume fragrances manufactured by a large number of perfume manufacturers. However, with literally thousands of perfume fragrances available for purchase from a large number of manufacturers, most buyers and users of perfume, must undergo an arduous process of smelling each perfume fragrance to ascertain if they like the smell for the intended purpose of the perfume. Alternatively, they can just take the advice of a sales representative as to what perfume they will like, however such advice may be skewed where the sales representative receives a bonus from individual perfume manufacturers based on sales.

Because the process is time consuming, and because the sense of smell of most buyers tires after just a few smell samples, they generally do not have a chance to find a perfume fragrance which they genuinely prefer above all others. Further, because they have no knowledge of which of the aroma components from the top, middle, and base notes they prefer, and, because the manufacturers do not publish the ingredients from these three groups contained in a final perfume fragrance, buyers have no easy manner to ascertain if they will like the scent provided by any individual perfume fragrance in advance. This is especially true because the scents from the second and third aroma groups since initially, the scent from the first aroma group, or top note, of the fragrance, is most prevalent to the buyer. They generally only smell the second note from the second aroma group and third note from the third aroma group, at a point in time subsequent to applying it to their person. Consequently, buyers may purchase a perfume fragrance which has a top note or fragrance from the first aroma group with is prevalent at purchase, only to find they do not like the perfume once the fragrances from the second and third aroma groups become more dominant.

Using a method of scent sequencing herein described and disclosed, the system herein provides buyers and users of perfume, a means to determine the individual aroma components with individual component scents which they prefer, from the top note or shortest lasting first aroma group, the middle note from the second longest lasting aroma group, and the base note from the third and longest lasting aroma group first. Thereafter, the system operator can provide the user with commercially available perfume scents which from pre-categorization of each such commercial scent, will match all or the most important of the preferences discerned for each user during the scent sequencing process. Additionally, the system herein provides a system for users to mix their own custom perfume fragrance based on input preferred scent characteristics ascertained from the scent sequencing and responses from each individual user. Optionally, the system provides users who opt to mix their own custom perfume fragrances the ability to sell such to other users and be paid for such.

The forgoing examples of related art and limitations related therewith are intended to be illustrative and not exclusive, and they do not imply any limitations on the user scent preference determination method described and claimed herein. Various limitations of the related art are already known or will become apparent to those skilled in the art upon a reading and understanding of the specification below and the accompanying drawings.

It is an object of this invention to provide a method and process allowing users to experience various blended scents whereafter using feedback of the respective preference for aroma components for each fragrance is identified whereafter each user can create a unique fragrance that can be utilized as a perfume.

An object of the present invention is to provide a system for ascertaining user preferences as to each of a plurality of aroma components mixed in a perfume fragrance, and to correlate the discerned aroma component preferences for each user, to commercially available perfume fragrances such users will prefer.

It is another object of the invention to enable users to mix their own custom perfume fragrance using provided aroma components from multiple aroma groups, based on the ascertained user preferences as to scents emitted by individual aroma components, as well as the determined preference for longevity of each, which are then employable to provide or mix a customized perfume fragrance.

### SUMMARY OF THE INVENTION

The present invention provides a system for ascertaining preferences of a user of perfume fragrances, based on a plurality of unique individual respective scents determined as being emitted from each of a plurality of aroma components ascertained as contained in a fragrance. By perfume fragrance is meant a finished mixed perfume, which may be worn by the user or another, which is formed from a mixture of a plurality of individual aroma components where each aroma component emits a determined unique scent, and a solvent such as alcohol. By aroma components is meant a natural or synthetic component or volatile chemical component, that emits a unique scent or fragrance, which humans and other animals perceive via the sense of smell or olfaction. Every aroma component thus emits an individual unique scent, and every perfume fragrance is made from one and generally a plurality of such aroma components.

The system herein operates in a first step by testing a plurality of commercially available perfume fragrances. In this first step, the individual aroma components which are present or contained in each such perfume fragrance, is determined. In this step which is preferably ongoing, each existing and new commercially available or specially mixed perfume fragrance or individualized fragrance, may be tested chemically or more preferably using electronic testing of each such perfume fragrance, to thereby ascertain each individual aroma component present therein.

Such electronic testing for example, may be accomplished for example by the employment of the ZNOSE device marketed by the Electronic Sensor Technology Company of Newbury Park, Calif., which through an electronic chemical vapor analysis process, discerns each of the aroma components of a perfume fragrance, and also the respective percentage of each included aroma component ingredient in the mixture of aroma components forming the perfume fragrance. Alternatively, the aroma components and percentages thereof in a perfume fragrance, may be ascertained by conventional or infrared spectroscopy using the device or services of commercial firms such as PerkinsElmer in Waltham, Mass. or those of similar firms providing services or devices which are also capable of ascertaining the individual aroma components of a perfume fragrance.

Subsequent to this first step, in an optional second step which is preferred herein, the ascertained individual aroma components found present in each respective tested perfume fragrance or individual aroma component, are categorized by a longevity in an aroma group. Therefor, for each perfume fragrance in the plurality tested, the presence of respective aroma components from a first aroma group with the shortest lasting scent emission, a second aroma component having a longer lasting scent emission than the first group, or a third aroma component group which are the aroma components with the longest lasting scent emission, is determined. In this fashion, the individual aroma components, from each commercially available perfume fragrance or custom mixed fragrance, may be determined. Thereafter itemized listings of the individual aroma components present in each individual commercially available perfume fragrance or custom fragrance, can be stored such as in an electronic memory in a component database. This component database will correlate the individual aroma components, present in any tested perfume fragrance. Additionally correlated and determinable will be which of the first, second, or third aroma component groups, to which each individual aroma component belongs. Thus, the individual aroma components and their unique scents, and the respective longevity of emission of each aroma component scent, is determined as to each respectively commercially available perfume fragrance or custom mixed fragrance.

As noted, in one preferred mode of the system, the conventional aroma components for each of the three longevity groups conventionally include for the first aroma group, extracted aroma components from citrus or grasses; for the second aroma group, aroma components which are spicy, floral or of fruit scents; and extracted aroma components from the third group may include aroma components from animals such as musk, or stronger or longer lasting extracts of plants which yield such a longer lasting scent. Using these groupings for the various individual scents emitted by individual aroma components and their longevity groupings, the system herein, can use the conventional system noted for longevity or can also form its own aroma longevity groups, and correlate the scent providing aroma components ascertained in any commercial perfume fragrance, to being components of the mixed perfume fragrance. In this fashion, each and every perfume fragrance in a plurality which can be thousands of such perfume fragrances, can be tested and have its respective individual aroma components discerned, and have those aroma components saved in a database relating to each respective perfume fragrance.

As noted, it is preferable to also place each of the discerned aroma components of each perfume fragrance in one of multiple aroma longevity groupings. Preferably, at least two groups are employed for groupings but especially preferred are three groupings of longevity. In such groupings the first aroma group will be those aroma components which emit an aroma scent which is determined to last the least amount of time in a perfume fragrance, but which conventionally are most immediately discerned by a user. Further, in such longevity groupings the second aroma group will be those aroma components which emit scents which are determined to last longer than those in the first aroma group, and are therefore present once the aroma components of the first aroma group have dissipated. Still further, where the preferred third aroma longevity group is employed in the categorization of the individual aroma components from a perfume fragrance, these third group aroma components will be those aroma components which are tested or known to emit a scent which lasts longer than both the first and the second aroma longevity groups.

As such, for each perfume ingredient or component in a perfume fragrance, the individual aroma components will be ascertained as noted above. Then, each such perfume fragrance will stored in a relational database and cross referenced in the database held in electronic memory, to the discerned individual aroma components present in each respective perfume fragrance. Preferably each such perfume fragrance will also have its discerned individual perfume components associated with an individual aroma longevity group showing the longevity such aroma components each emit a scent.

With a library of perfume fragrances held in electronic memory which is accessible to a computer running software operating to correlate each perfume fragrance held in a listing or database of fragrances, to known respective aroma components and determined aroma longevity groups to which those aroma components belong, the system herein is employable to determine the perfume fragrances users prefer, based on the scent sequencing provided by the system provider and user responses. It is also employable for users subsequent to undergoing scent sequencing, and identification to users of their aroma component preference and/or aroma longevity group preference, to formulate their own custom perfume fragrance based on their responses to the scent testing conducted during scent sequencing.

With the library of perfume fragrances stored in memory and cross referenced with the aroma components and preferably the aroma longevity groups to which the aroma components are associated, each user may be provided a graphic interface or other means such as a paper form, wherein the user registers with the system provider. Such registration will include user name, contact information, mailing address, and other information concerning each user, whereafter they will be a registered user and the steps in scent sequencing will commence.

In a subsequent step, scent sequencing will begin where each registered user will be sent a shipment including a first plurality of individual scent packages where each contains a different perfume fragrance from those held in inventory by the provider and having known aroma components in the library of perfume fragrances. Currently a plurality of five scent packages is preferred as it has been found such is a number allowing the user to smell or wear each of the individual perfume fragrances in each packet over a duration of time such as two weeks. While current experimentation shows that between four to six individual scent packages yields accurate results with users as to preferences, the plurality provided could be any number of individual scent packages. The receipt of the first plurality of scent packages allows the registered user to smell and access each scent package and the perfume fragrance therein, while it is applied to their person.

In a next step, the user in a first user preference response, will input online or a form or will be contacted by email or telephone message or text messaging, and requested to communicate their use preference, as to like and dislike from the first plurality of five scent packages. The response can be by email or text messaging, or the registered user may login to the provider website, and input their preferences using a provided graphic interface.

Subsequent to the first user preference input as to perfume fragrance preferences, each registered user will be shipped a second sequence of a plurality of perfume fragrances, where each is also in a sealed individual package. This second sequence of plurality of perfume fragrances may be chosen by the system provider, based on the provided first preference as to the respective registered user's favorite perfume fragrances from the first plurality of scent packages. The plurality of perfume preferences sent in the second sequence, will be accomplished by determining the individual aroma components, and aroma longevity groups which more closely correlate to the user preferred scent packages from the first plurality perfume fragrances, and then choosing different individual perfume fragrances, which include the same or closely related aroma components contained in the favored first sequence of perfume fragrances.

Subsequent to the shipment of the second sequence of perfume fragrances in individual sealed containers, the registered user provides a second preference for each of the plurality of perfume fragrances. The user may be contacted by email or telephone message or text messaging, and requested to communicate in a second preference response, their preferences as to like and dislike of individual perfume fragrances included in the second plurality of five scent packages. In addition to email or text messaging, this second user preference response may be provided by the registered user who may login to the provider website, and input their second preferences using a provided graphic interface.

Subsequent to this second preference response by the registered user as to likes and dislikes from the second plurality of individual perfume fragrances sent them, the identity of the perfume fragrances correlating to the aroma components determined in their second preferences may be revealed to the registered user from the library of perfume fragrances held in electronic memory. In a Subsequent step, the registered user may be provided a graphic interface to order and purchase the identified favored perfume fragrances.

Alternatively, and as is preferred for more accuracy as to matching a perfume fragrance to each individual registered user, each registered user may be shipped a third sequence including a third plurality of perfume fragrances, where each perfume fragrance is also in a sealed individual package. This third sequence of plurality of perfume fragrances may be chosen by the system provider, based on the user preferences as to likes and dislikes included in the first user response in combination with the second user response, as to the respective registered user's favored perfume fragrances from the first plurality of scent packages as well as the second plurality of scent packages.

Such will be accomplished by determining the individual aroma components and individual aroma longevity groups correlating to the user preferred scent packages from the first plurality perfume fragrances as well as the second plurality of scent packages, and then employing software operating to the task of ascertaining different individual preferred perfume fragrances, from stored electronic library of fragrances, which include the same or closely related aroma components favored by the registered user in both the first sequence of perfume fragrances and the second sequence of perfume fragrances. Additionally employed in choosing the preferred perfume fragrances can be the aroma longevity group to which the discerned preferred aroma components belong. This can be done by asking for user input as to a preference for a preferred perfume fragrance as to longevity group so the user may decide which aroma component and duration they value most.

Subsequent to the shipment of the third sequence of perfume fragrances in individual sealed containers, the registered user may again provide a fourth user preference. The registered user may again be contacted by email or telephone message or text messaging, and requested to communicate in a third preference response, their preferences as to like and dislike of individual perfume fragrances included in the third plurality of, for example, five scent packages. This third user preference response can be by email or text messaging, or the registered user may login to the provider website, and input their third preference response using a provided graphic interface.

With this third user preference response or input of favored perfume fragrances from the third plurality of fragrances, the system provider can again determine using software running in electronic memory to cross reference and determine which aroma components held in electronic memory and related to each respective individual perfume fragrance, were included in all user preference responses as to favored perfume fragrances from the first, second, and third sequence of perfume fragrances which were sent to the registered user. The determination has been found in experimentation to yield a very accurate prediction of determined individual perfume fragrances, from the library of perfume fragrances available, the registered user will like. Adding a determination of the aroma longevity group to which the individual aroma components belong, enhances the accuracy of the determined perfume fragrances a user will prefer, as does having the user indicate a preference for an aroma longevity group they prefer.

It should be noted that the system can include shipments of a fourth and fifth or more sequences of perfume fragrances if it is determined to yield more accurate results, or, if the registered user upon query requests subsequent perfume fragrances be sent. Currently, however, excellent results for accuracy as a registered user's preferences have been found after the third sequence has been completed by users.

At this juncture, the identity of the determined perfume fragrances for a user may be communicated to the registered user. Thereafter the user may be presented with a graphic interface allowing the user to input an order for one or more of the identified determined perfume fragrances for that user or may order using a paper form or email or other means to input an order.

In an additional and particularly preferred step, the system herein can be employed to enable a registered user to formulate their own custom perfume fragrance from the available aroma components provided and mixed by the system provider. In this mode, identified aroma components which correlate to the input preferred perfume fragrances from the first, second, and if provided, the third sequence of perfume fragrances, as being present in those preferred perfume fragrances may be identified to the registered user. The user in this next step is provided a list of their respective preferred aroma components. This may be with a graphic interface or means. Thereafter the user may input and to designate a plurality of the identified aroma components identified as preferred by that registered user from prior input noted above, for inclusion in a custom perfume formulation for the individual registered user. Thereafter the system provider will mix the custom perfume formulation based on the registered user input, and provide the registered user a container of the custom perfume formulation.

Additionally, in another step in the system, the registered user may be given the option to include their custom perfume formulation in the library of perfume fragrances available, which is held in a list in electronic memory of the system provider. Thereafter, the custom perfume formulation may be made available for sale to other registered users, and may be included in one of the first, second, or third sequence of perfume fragrances sent to other users whereby they may identify it as preferred and be given the ability to order it.

Still further, in an optional step, the user may be informed, as to which of the three aroma longevity groups each of the aroma components belongs. The user will thus be given the components present in a particular perfume fragrance from the shortest lasting first aroma longevity group, those from the longer lasting second aroma longevity group, and those from the longest lasting third aroma longevity group. In this fashion, knowing the proclivity of each perfume fragrance component for longevity, the registered user can decide which of the aroma components they wish to dissipate first and which they wish to include because they last longer. This optional step may be included in the formulation of custom perfume fragrances by the user, or, in a step after the second or third user preference input of preferred perfume fragrances to give the registered user more information about how the individual perfume fragrances will smell, short term, mid term, and long term.

With respect to the above description, before explaining at least one preferred embodiment of the herein disclosed perfume fragrance sequencing system in detail, it is to be understood that the invention is not limited in its application to the details of construction and to the arrangement of the steps in the following description or illustrated in the drawings. The invention herein described is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other perfume preference determination systems for carrying out the several purposes of the present disclosed system. It is important, therefore, that the claims be regarded as including such equivalent construction and methodology insofar as they do not depart from the spirit and scope of the present invention.

Further objectives of this invention will be brought out in the following part of the specification wherein detailed description is for the purpose of fully disclosing the invention without placing limitations thereon.

### BRIEF DESCRIPTION OF DRAWING FIGURES

FIG. 1 depicts a graphical depiction of the scent sequencing system or method herein for determining user preferences for perfume fragrances by providing a plurality of perfume fragrances having determined individual aroma components, each of which are categorized in aroma longevity groups.

FIG. 2 is a continuation of the steps of the system of FIG. 1.

It should be noted the steps in the system may be reordered and that other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, any directional prepositions if employed, such as up, upwardly, down, downwardly, front, back, top, upper, bottom, lower, left, right and other such terms refer to the device or depictions as such may be oriented are describing such as it appears in the drawings and are used for convenience only. Such terms of direction and location are not intended to be limiting or to imply that the device or method herein has to be used or positioned with graphics in any particular orientation. Further, computer and network terms such as electronic memory, database, network, browser, media, digital files, videos and other terms are for descriptive purposes only, and should not be considered limiting, due to the wide variance in the art as to such terms depending on which practitioner is employing them. The system herein should be considered to include any and all manner of software, firmware, operating systems, executable programs, files and file formats, databases, computers, electronic memory in communication with a computer, computer languages and the like, and communications ability electronically or using paper, as would occur to one skilled in the art in any manner as they would be described.

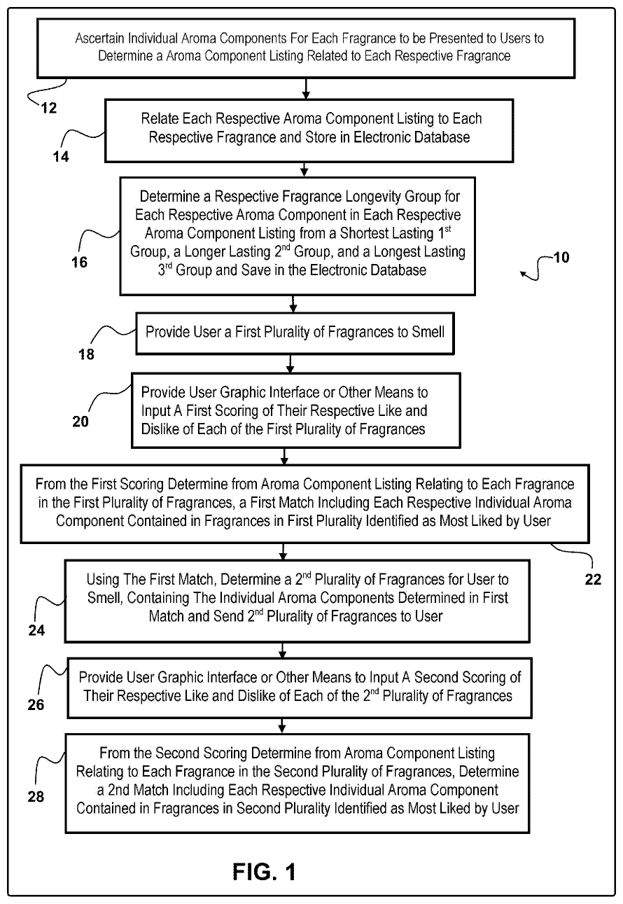

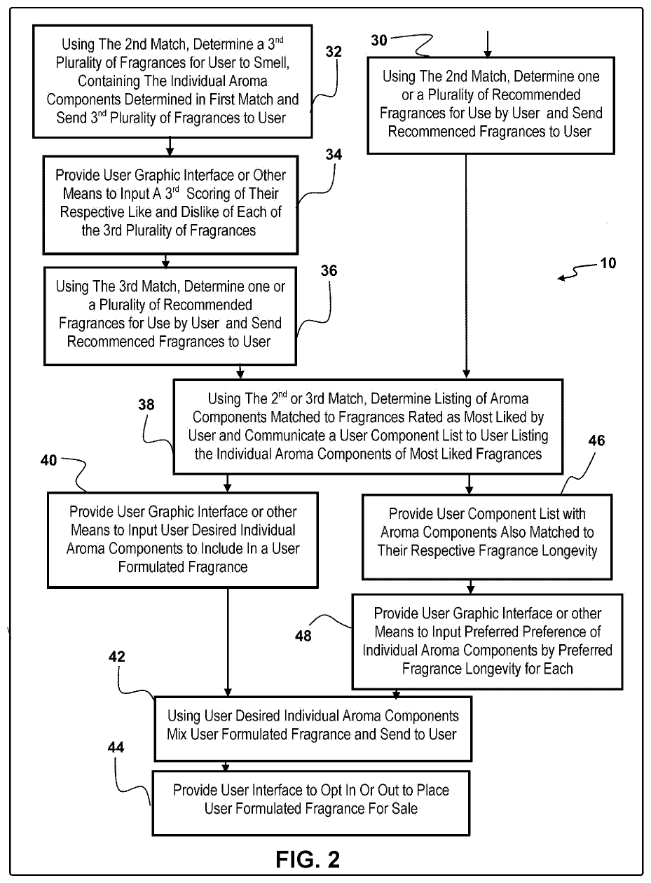

Now referring to drawings in FIGS. 1-2 herein, there is depicted a graphical showing of the fragrance customization system 10 herein and the steps or method for determining user preferences for scents in such a customization.

The steps in the system 10 herein as shown in FIG. 1 and continuing from FIG. 1 to FIG. 2, as noted, provide a scent sequencing method for ascertaining the preferred fragrance preferences of a user based on the aroma components of a perfume fragrance, and optionally the user preference as to the longevity group of each identified user preferred aroma component of a particular perfume fragrance. By perfume fragrance is meant, any perfume or other liquid fragrance formed from one or a plurality of aroma components which emit a scent for a duration of time, such as for example commercially available perfume fragrances which are mixtures of multiple aroma components each of which emits a unique scent for a duration of time.

In a step 12 of the system 10 shown in FIG. 1, the system provider will ascertain the individual aroma components which are contained in each respective perfume fragrance to be presented to users to smell and rate. As noted above, various machines and systems are available for sampling perfume fragrances and determining the one or more individual aroma components contained in a perfume fragrance and the relative amounts of each aroma component by percentage by weight or volume of a mixed perfume fragrance based on a percentage of the sampled amount.

In a subsequent step 14 an aroma component listing of each aroma component determined present in each respective known perfume fragrance, and the amounts of each aroma component in each respective perfume fragrance, is associated with each perfume fragrance. Such may be compiled in an electronic database of a plurality of perfume fragrances in relation to the respective individual aroma components contained in each respective perfume fragrance, and stored in electronic memory. Consequently, for any perfume fragrance tested, the system provider herein will have stored information of each aroma component contained in each respective perfume fragrance and the percentage of the whole each such aroma component provides. Such may be stored in a relational database of perfume fragrances in electronic memory where the individual aroma components in each fragrance and the amounts thereof is easily determined and used in the scent sequencing system herein.

In an optional but preferred step 16 in the system 10 aroma longevity groups for each aroma component of the individual aroma components within each perfume fragrance may be determined. The longevity groups separate the aroma components by a known or a determined longevity of emission of a scent from each aroma component. Each aroma component will be associated with either a first aroma longevity group, which is determined to have a shortest lasting emission of scent, a longer lasting second aroma longevity group of aroma components which are determined to emit scent longer than those of the first aroma longevity group, and a third aroma longevity group of aroma components determined to emit discernable scent longer than both the first group and second group of aroma components.

This step 16 of associating each aroma component as to being in one of three longevity groups or having a longevity rating, is preferred. This is because the system provider may then give users a choice to view determined longevity of the individual aroma components and use that information for identified aroma components they may request in a preferred perfume fragrance or a user ordered mixture of aroma components, or in sending the user available perfume fragrance mixtures subsequent to user testing based on their input preferences.

As noted above, for a large number of aroma components used in perfume fragrances, such aroma components are conventionally already included in one of these three groups and such information is available for use as available or as customized by the system provider. However, consumers are not privy to such information and generally have no idea how a fragrance smells on their person initially, will not be the same in a few hours, and will differ again by the next day. For aroma components for which such longevity information is not available, the scent longevity of such aroma components may be tested and using humans or scent detecting machinery they may be categorized into one of the three aroma longevity groups.

In a next step 18, system provider sends the user a first plurality of perfume fragrance samples for the user to smell. Such samples may be liquid, gel, wicks, or other types of perfume fragrance samples which are sent in a sealed container. Currently a plurality of 4-6 perfume fragrance samples is preferred as experimentation has shown better results with the ultimate choices by the user with this plurality of perfume fragrance samples being sent.

Subsequent to sending the user a first plurality of perfume fragrance samples to smell and rate, in a next step the user provides a first user preference response. Such is preferably provided with a graphic interface but could also be provided with a form, which queries the user concerning their user preferences as to each of the first plurality of perfume fragrances samples, in a first scoring 20.

In this step, for a first user preference response, the user is provided with a means to input a scoring of their respective review of each of the first plurality of perfume fragrance samples. Such a first user preference may be provided on paper, email, text, or other means for input. Currently, such is provided by a graphic interface communicated to and displayable on the local display of the computing device of the user. Using the response preference interface, the user can communicate a first scoring. This may be a yes or no, or may be a rating by number or letter or other sequential rating system from a highest preference as to individual perfume fragrance samples they most liked, to a lowest rating relating to those of the first plurality of perfume fragrance samples the user least liked.

In a subsequent step 22, first user preference response or scoring from the user is employed to determine the aroma components in the component listing relating to each of the plurality of first perfume fragrance samples sent to the user, and thereby determine a first match of individual aroma components which correlate to the most liked of the first plurality of perfume fragrances.

This first match of aroma components yields a listing of the each respective individual aroma component, contained in the highest rated perfume fragrance sample or samples, based on the associated individual aroma components associated with the highest rated sample perfume fragrances sent the user, from the database of perfume fragrances and associated perfume fragrance components stored in electronic memory. Currently the highest rated perfume fragrance responses for sampling by users includes the first and second highest rated perfume fragrances noted in the first preference response.

In a next step 24, employing the determined individual aroma components contained in each respective perfume fragrance in the database from the first match, a second plurality of perfume fragrances is chosen to send the user. Preferably all of the second plurality of perfume fragrances sent to the user is determined as containing at least some of the individual aroma components, in the most liked perfume fragrance sample or samples, in the first match.

This second plurality of sample perfume fragrances is then sent to the user for smell testing by the user. While it should be noted the system 10 could skip subsequent user preference responses and ratings and sending of subsequent pluralities of perfume fragrance samples, and simply send the user either actual perfume fragrances shown to match their preferences, or a list to choose aroma components to include in a mix after one test, it has been found that at least two and more preferable three such pluralities of samples and user responses as to user preferences therefor, provided better results as to ultimate user preferences for perfume fragrances.

Subsequent to sending the user the second plurality of perfume fragrance samples, in a next step 26 the user inputs a second preference response indicating the most preferred of the plurality of perfume fragrances. Such may be provided in email, text messaging, or on paper or other means. Preferably, this second preference response is input using a second graphic interface which queries the user concerning their second preference response as to each of the second plurality of perfume fragrances samples.

As in the prior user rating and preference step, the user inputs another user preference or scoring of their respective review of each of the second plurality of perfume fragrance samples sent. Using a second input interface or other written or electronic communication of the second preference response, the user can communicate this second preference or scoring. Such might be a yes or no, a rating by number, or letter or an other sequential rating system, from a highest preference as to individual perfume fragrances from the second plurality they most liked. Upon communication of the second preference response from a user, as to their preference for each of the second plurality of perfume fragrance samples, the response and preference or second scoring is determined and also associated with the respective user sending it.

In a next step 28, employing the second scoring from the second preference response, as correlated with the aroma component listing held in the database of perfume fragrances relating to each perfume fragrance sent the user in the second plurality of perfume fragrances, a second match is determined. This second match includes each respective individual aroma component identified as contained in the most favored perfume fragrances from the second preference response from the user as to the second plurality of perfume fragrances.

At this juncture, as shown in the drawings, using this second match of determined individual aroma components, in one mode of the system, one or a plurality of recommended perfume fragrances containing the identified aroma components may be determined for the user and those determined perfume fragrances may be sent to the user 30. Also, if the user is to custom mix a fragrance, a list of the determined aroma components can be communicated to the respective user and employed subsequently for user input as to which of the aroma components on the list, to include in a custom mixed perfume fragrance.

Alternatively, but preferred in a most accurate determination of user scent and aroma preferences, a next step using the second match 32 correlates with the database of perfume fragrances and determines the individual aroma components contained in the most preferred perfume fragrances from the second match. This determination of the individual aroma components in the favored perfume fragrances from the second set of perfume fragrance samples, provides a third aroma component listing, for each perfume fragrance in the database second match. This third aroma component listing is correlated with the component listings for each perfume fragrance in the perfume fragrance database, and a third plurality of perfume fragrances is chosen to send the user. Like the second plurality of perfume fragrances, this third plurality of perfume fragrances includes only perfume fragrances which have the respective individual aroma components in the third aroma component listing, and may or may not include some of the same perfume fragrances from the second plurality of perfume fragrances sent the user.

Subsequent to sending the user a third plurality of perfume fragrance samples, in a next step 34, the user provides a third preference response. Such, again, may be provided by email, text messaging, paper and mail, but is preferably provided with a third graphic interface for scoring, in which the user provides a third preference response as to each of the third plurality of perfume fragrances samples. As in the prior user rating step, the user is communicates a yes or no or a scale scoring of their respective review of each of the third plurality of perfume fragrance samples sent.

Using this third scoring interface or by email, text messaging or mail, the user provides the third preference response and communicates the third scoring which is a rating by number or letter or other sequential rating system from a highest preference as to individual perfume fragrances from the third plurality they most liked.

In a next step 38 using second match and/or third match, a user aroma component listing, containing the respective individual aroma components matched to perfume fragrances rated as most liked by the user, in the prior matches from prior user preference responses is determined. These are the individual aroma components found in the perfume fragrances most liked by the user in the prior pluralities of perfume fragrances smelled and rated in a user response.

Once this user preferred aroma components list is ascertained, the system 10 herein can in one preferred mode takes the step 40 of communicating to the user a respective list of their most preferred aroma components. This will allow the user to choose and input a response of aroma components from their most preferred aroma components, to be included in a commercially available perfume fragrance or one which is custom mixed for the user. Such input can be by email, text messaging, paper, or preferably by graphic interface or other input means whereby the user may input their respective user desired individual aroma components to include in a user formulated perfume fragrance which will be mixed by the service provider for the user.

In a subsequent step 42 employing the user response indicating the desired individual aroma components identified by the user, the system provider may have the user-formulated perfume fragrance mixed and delivered to the user.

The user in another step 44 will be provided with the ability to opt in or out of placing their respective user formulated perfume fragrance for sale to other users and third parties.

Alternatively, after the step 38 and/or prior step 40, in a step 46 allowing the user to employ the longevity of the individual aroma components, the user can be provided with the user preferred aroma component list, and listings of the aroma components on the list which are correlated to respective perfume fragrance aroma longevity group of each aroma component in the user component list. Such allows the user to choose aroma components which are in the first aroma longevity group, the second aroma longevity group, or third aroma longevity group in making their decision in their response as to what aroma components to include in a custom-mixed perfume fragrance or to include in a commercial perfume fragrance sent by the system provider.

In a next step 48, once step 38 has been accomplished, the user may simply input the aroma components chosen from the list sent the user for inclusion in a custom perfume fragrance or commercial one, after reviewing their respective longevity from the longevity associated and communicated to the user of each. Alternatively, the user can input a choice for preferred longevity which can be employed along with the chosen aroma components where the user preference of longevity is given the hire rating when including aroma components in a custom or commercially provided perfume fragrance.

In this step, the user can be communicated the respective three aroma longevity groups where the aroma components on the list provided the user as favored, and associated with one of the three groups. The user can input a longevity choice by electronic or paper communication such as a graphic interface or other means to input a user preferred preference of individual aroma components based on the user preferred aroma component longevity group, for each of the aroma components in the user component list. Such will allow the user not only to choose which of the known aroma components from their respective determined favored user component list to include in a perfume fragrance, it allows them to choose what to include in the user formulated perfume fragrance in step 42, based on their individual preference for longevity for the chosen user aroma components to include. Or as noted, they can simply be provided with the longevity information, for each of the aroma components identified as favored by the user, and use that information to choose aroma components for inclusion know which is lasting longer or shorter in their choice.

While all of the fundamental characteristics and features of the sequential perfume fragrance determination system herein have been shown and described herein, with reference to particular embodiments thereof, a latitude of modification, various changes and substitutions are intended in the foregoing disclosure and it will be apparent that in some instances, some features and/or steps of the invention may be employed without a corresponding use of other features and/or steps without departing from the scope of the invention as set forth. Further as those skilled in the art will realized the steps may be reordered and some included without the others and all such reordering and inclusion or non inclusion is considered within the scope of this invention.

Further it should also be understood that upon reading this disclosure and becoming aware of the disclosed novel and useful system, various substitutions, modifications, and variations may occur to and be made by those skilled in the art without departing from the spirit or scope of the invention. Consequently, all such modifications and variations and substitutions, as would occur to those skilled in the art are considered included within the scope of the invention as defined by the following claims.

What is claimed is:

1. A method for determining user preferences for perfume fragrance comprising the steps of:
determine individual aroma components contained in each respective perfume fragrance in a group of perfume fragrances;
provide a first plurality of perfume fragrances from said group of perfume fragrances to a user;
based on a first preference response from a user determining first perfume fragrance preferences from said first plurality of perfume fragrances, determine a first preferred group of individual aroma components, contained in respective said first perfume fragrance preferences;
send user a second plurality of perfume fragrances chosen from said group of perfume fragrances where said second plurality of perfume fragrances contain said first preferred group of aroma components;
based on a second preference response from a user determining second perfume fragrance preferences from said second plurality of perfume fragrances, determine a second preferred group of individual aroma components, contained in respective said second perfume fragrance preferences; and
send user recommended perfume fragrances containing respective said aroma components included in said second preferred group of individual aroma components.

2. The method of claim 1, additionally including:
sending user a third plurality of perfume fragrances chosen from said group of perfume fragrances where said third plurality of perfume fragrances contain said second preferred group of aroma components;
based on a third preference response from a user determining third perfume fragrance preferences from said third plurality of perfume fragrances, determine a third preferred group of individual aroma components, contained in respective said second perfume fragrance preferences; and
sending user said recommended perfume fragrances containing respective said aroma components which are included in said third preferred group of individual aroma components.

3. The method of claim 1, additionally including
catagorize each of said individual aroma components contained in each respective perfume fragrance to one of, a first aroma longevity group where said individual aroma component emits a scent for a first duration of time, a second aroma longevity group where said individual aroma component emits a scent for a second duration of time longer than said first duration of time, and a third aroma longevity group where said individual aroma component emits a scent for a third duration of time longer than said second duration of time; and
communicating to said user a listing of said second preferred group of individual aroma components, contained in respective said second perfume fragrance preferences;
communicating to said user which of said second preferred group of individual aroma components is in said first aroma longevity group;
communicating to said user which of said second preferred group of individual aroma components is in said second aroma longevity group;
communicating to said user which of said second preferred group of individual aroma components is in said third aroma longevity group;
based on a group preference response from a user indicating a preferred longevity group for respective said aroma components which are in one of, said first aroma longevity group, second aroma longevity group, and third aroma longevity group, send user recommended perfume fragrances containing respective said aroma components included in said second preferred group of individual aroma components which are also in said preferred longevity group.

4. The method of claim 2, additionally including
catagorize each of said individual aroma components contained in each respective perfume fragrance to one of, a first aroma longevity group where said individual aroma component emits a scent for a first duration of time, a second aroma longevity group where said individual aroma component emits a scent for a second duration of time longer than said first duration of time, and a third aroma longevity group where said individual aroma component emits a scent for a third duration of time longer than said second duration of time;
communicating to said user which of said third preferred group of individual aroma components is in said first aroma longevity group;
communicating to said user which of said third preferred group of individual aroma components is in said second aroma longevity group;
communicating to said user which of said third preferred group of individual aroma components is in said third aroma longevity group; and
based on a group preference response from said user indicating a preference group for respective said aroma components which are in one of, said first aroma longevity group, second aroma longevity group, and third aroma longevity group, send user recommended perfume fragrances containing respective said aroma components included in said third preferred group of individual aroma components which are also in said preference group.

5. A method for determining user preferences for perfume fragrance comprising the steps of:
determining individual aroma components contained in each respective perfume fragrance in a group of perfume fragrances;
providing a first plurality of perfume fragrances from said group of perfume fragrances to a user;
based on a first preference response from a user determining first perfume fragrance preferences from said first plurality of perfume fragrances, determine a first preferred group of individual aroma components, contained in respective said first perfume fragrance preferences;
sending user a second plurality of perfume fragrances chosen from said group of perfume fragrances where said second plurality of perfume fragrances contain said first preferred group of aroma components;
based on a second preference response from a user determining second perfume fragrance preferences from said second plurality of perfume fragrances, determine a second preferred group of individual aroma components, contained in respective said second perfume fragrance preferences;
sending user a component list of said respective said aroma components included in said second preferred group of individual aroma components; and
based on response from user choosing said aroma components listed on said component list to include in a custom perfume fragrance, mix said custom perfume fragrance and send to user.

6. The method of claim 5, additionally including:
sending user a third plurality of perfume fragrances chosen from said group of perfume fragrances where said third plurality of perfume fragrances contain said second preferred group of aroma components;
based on a third preference response from a user determining third perfume fragrance preferences from said third plurality of perfume fragrances, determine a third preferred group of individual aroma components, contained in respective said third plurality of perfume fragrances;
sending user said component list of said respective said aroma components included in said third preferred group of individual aroma components; and
based on response from user, choosing said aroma components listed on said component list to include in a custom perfume fragrance, mix said custom perfume fragrance and send to user.

7. The method of claim 5, additionally including
catagorize each of said individual aroma components contained in each respective perfume fragrance to one of, a first aroma longevity group where said individual aroma component emits a scent for a first duration of time, a second aroma longevity group where said individual aroma component emits a scent for a second duration of time longer than said first duration of time, and a third aroma longevity group where said individual aroma component emits a scent for a third duration of time longer than said second duration of time; and
communicating to said user said listing of said second preferred group of individual aroma components, contained in respective said second perfume fragrance preferences;
communicating to said user which of said second preferred group of individual aroma components is in said first aroma longevity group;
communicating to said user which of said second preferred group of individual aroma components is in said second aroma longevity group; and
communicating to said user which of said second preferred group of individual aroma components is in said third aroma longevity group.

8. The method of claim 6, additionally including
catagorize each of said individual aroma components contained in each respective perfume fragrance to one of, a first aroma longevity group where said individual aroma component emits a scent for a first duration of time, a second aroma longevity group where said individual aroma component emits a scent for a second duration of time longer than said first duration of time, and a third aroma longevity group where said individual aroma component emits a scent for a third duration of time longer than said second duration of time;
communicating to said user which of said third preferred group of individual aroma components is in said first aroma longevity group;
communicating to said user which of said third preferred group of individual aroma components is in said second aroma longevity group; and
communicating to said user which of said third preferred group of individual aroma components is in said third aroma longevity group.
